(19) United States
(12) Patent Application Publication
(10) Pub. No.: US 2004/0096688 A1
(43) Pub. Date: May 20, 2004

(54) Lead-free joining material and joining method using the same

(75) Inventors: Masahiro Tadauchi, Yokohama-shi (JP); Izuru Komatsu, Yokohama-shi (JP); Kazutaka Matsumoto, Yokohama-shi (JP); Isao Suzuki, Kimitsu-shi (JP); Yuko Imamura, Fukaya-shi (JP)

Correspondence Address: FOLEY AND LARDNER, SUITE 500, 3000 K STREET NW, WASHINGTON, DC, 20007, US

(73) Assignee: KABUSHIKI KAISHA TOSHIBA

(21) Appl. No.: 10/697,098

(22) Filed: Oct. 31, 2003

(30) Foreign Application Priority Data
Oct. 31, 2002 (JP) 2002-318817

(51) Int. Cl. B32B 15/02

(52) U.S. Cl. 428/570

(57) ABSTRACT

A lead-free joining material includes zinc and tin as major components, and at least any one of bismuth and germanium as an additive element. The joining material includes a core part, and a surface layer covering the core part. The surface layer includes a solid-solution phase which contains the tin as a main component and a needle crystal which is dispersed in the solid-solution phase and contains the zinc as a main component. Moreover, a concentration of the additive in the solid-solution phase is higher than a concentration of the additive element in the core part, and the concentration of the additive element in the solid-solution phase is in a range of 0.6 to 4.0% by weight.

### CROSS REFERENCE TO RELATED APPLICATION

This application is based upon and claims the benefit of priority from prior Japanese Patent Application No. 2002-318817, filed on Oct. 31, 2002; the entire contents of which are incorporated herein by reference.

### BACKGROUND OF THE INVENTION

1. Field of the Invention

The present invention relates to lead-free joining materials. More specifically, the invention relates to a lead-free joining material including a tin-zinc alloy as a major component with addition of bismuth and the like, and to a method of joining metallic members using the joining material.

2. Description of the Related Art

Soldering is an art of joining objects by use of a material with a low melting point than that of the object, and has been used since old times. Soldering is widely used to manufacture electronic devices starting with joining semiconductor devices and electronic components such as microprocessors, memories, resistors, capacitors or the like onto mounted substrates. Advantages of soldering reside characteristics of not only fixation of components on substrates but also of electrical connection utilizing conductivity of metals included in solder. Along with today's rapid diffusion of personal devices represented by personal computers, cellular telephones, pocket pagers and the like, soldering has been gaining more importance in the technology of mounting electronic components.

Solder generally used today has been eutectic solder composed of tin and lead. The eutectic tin-lead solder possesses excellent wettability on copper plates and a low melting point of 183° C., and is therefore very suitable for practical use. Nevertheless, it comes to public attention that the lead included in the eutectic tin-lead solder is harmful to human health. Therefore, it is urgently necessary to develop so-called lead-free solder, which includes no lead, for replacing the eutectic tin-lead solder.

At present, tin-silver alloys, tin-zinc alloys, and the like are mainly considered as the lead-free solder; however, both of the alloys have melting points higher than the conventional eutectic tin-lead solder. Above all, a tin-silver alloy has an extremely high eutectic point of 211° C. Accordingly, heat damages may occur due to a reflow temperature when joining electronic components. On the contrary, a tin-zinc alloy has a eutectic point of 199° C. With the use of tin-zinc alloy, it is possible to set a low reflow temperature compared to the tin-silver alloy or even a lower reflow temperature when bismuth is added thereto. Accordingly, it is possible to prevent the occurrence of heat damages in electronic components and together improve workability.

For example, lead-free solders known to include a tin-zinc alloy are those using tin-zinc alloys with bismuth of 3% by weight added, or a tin-zinc alloy with bismuth and the like of more than 1 and less than 3% by weight added.

As described above, the melting point of the tin-zinc alloy is lower than that of the tin-silver alloy, and it is possible to set the melting point even lower by adding bismuth and the like thereto. On the contrary, an increase in the concentration of bismuth and the like added causes an increase in brittleness of the alloy. Accordingly, when using the conventional tin-zinc alloy including bismuth of more than 1 up to 3% by weight as the solder, a crack is apt to occur in a joint. Such brittleness becomes a serious problem particularly in consumer components for cellular telephones or pagers and the like which require shock-resistant by falling, for example. Hence there is a demand for improving the brittleness of tin-zinc alloy with bismuth added.

### SUMMARY OF THE INVENTION

A detailed analysis has not been carried out previously in light of a relation between the microstructure of tin-zinc alloy and the amount of bismuth added. Therefore, the inventors of the present invention conducted the analyses of the relation between the amount of bismuth added and the microstructure, which have resulted in unprecedented findings.

Based on these findings, it is an object of the present invention to provide a lead-free joining material including tin-zinc alloy which has high joining strength and fine wettability, and to provide a method of joining metallic members using the lead-free joining material.

Lead-free joining material according to an aspect of the present invention includes a core part and a surface layer covering the core part, and each of them contains zinc and tin as major components and at least one of bismuth or germanium as an additive element. Moreover, the surface layer includes a solid-solution phase and a needle crystal dispersed in the solid-solution phase. A concentration of the additive element in the surface layer is higher than a concentration of the additive element in the core part and the concentration of the additive element in the solid-solution phase is in a range of 0.6 to 4.0% by weight. The needle crystal contains the zinc as a main component. Here, the major components of the lead-free joining material mean components which are included greater than the additive element in the lead-free joining material. The main component of the needle crystal means a component in which the needle crystal essentially consists.

According to the above-described aspect of the present invention, the surface layer includes a layer with high-concentration of bismuth or germanium. Therefore, it is possible to lower the melting point of the surface layer and to initiate joining smoothly. Moreover, since the amount of bismuth or germanium is maintained small in the core part, the amount of additive element in the joining material as a whole is less than the conventional lead-free joining material. Hence it is possible to prevent occurrence of cracks and the like after joining.

Meanwhile, needle crystals are deposited on the surface of the lead-free joining material by setting the concentration of bismuth or germanium to 0.6% by weight or more. However, the zinc existing in the needle crystals as the main component tends to form a compound with a metallic member. Accordingly, when joining, it is possible to obtain high adhesive strength to metal such as an electrode as an object of joining. Moreover, by setting the concentration of bismuth or germanium additive in the solid-solution phase of the surface layer within 4.0% by weight, it is possible to suppress formation of asperities on the surface associated with the growth of the needle crystal. By suppressing formation of the asperities, it is possible to prevent imperfect joining arising from the asperities when joining with use of this lead-free joining material.

A solder paste according to an aspect of the present invention includes a lead-free joining material containing zinc and tin as major components and at least any one of bismuth or germanium as an additive element, and a flux. The lead-free joining material includes a core part and a surface layer covering the core part. Moreover, the surface layer includes a solid-solution phase and a needle crystal dispersed in the solid-solution phase. A concentration of the additive element in the surface layer is higher than a concentration of the additive element in the core part and the concentration of the additive element in the solid-solution phase is in a range of 0.6 to 4.0% by weight. The needle crystal contains the zinc as a main component.

According to the aspect of the solder paste described above, when joining by use of this solder paste, it is possible to provide joining with fine wettability, high joining strength, and resistance against cracks attributable to the characteristic of the lead-free joining material. Imperfect joining is reduced and occurrence of cracks at a connection can be thereby suppressed.

A joining method according to an aspect of the present invention includes coating a solder paste to a connection and reflowing the solder paste. The solder paste is formed by blending a flux with a lead-free joining material including zinc and tin as major components and at least any one of bismuth and germanium as an additive element. The lead-free joining material includes a core part and a surface layer covering the core part. Moreover, the surface layer includes a solid-solution phase and a needle crystal dispersed in the solid-solution phase. A concentration of the additive element in the surface layer is higher than a concentration of the additive element in the core part and the concentration of the additive element in the solid-solution phase is in a range of 0.6 to 4.0% by weight. The needle crystal contains the zinc as a main component.

A joining method according to another aspect of the present invention includes placing lead-free joining material on a connection where flux is coated in advance and reflowing the flux and the lead-free joining material. The lead-free joining material includes a core part and a surface layer covering the core part. Moreover, the surface layer includes a solid-solution phase and a needle crystal dispersed in the solid-solution phase. A concentration of the additive element in the surface layer is higher than a concentration of the additive element in the core part and the concentration of the additive element in the solid-solution phase is in a range of 0.6 to 4.0% by weight. The needle crystal contains the zinc as a main component.

According to the joining methods of the above described respective aspects of the present invention, it is possible to provide joining with fine wettability, high joining strength, and resistance against cracks attributable to the characteristic of the lead-free joining material.

### BRIEF DESCRIPTION OF THE DRAWINGS

FIG. 1A is a view showing a cross-sectional structure of a lead-free joining material according an embodiment of the present invention.

FIG. 1B and FIG. 1C are partially enlarged cross-sectional views of the lead-free joining material according to the embodiment of the present invention.

FIG. 2A to FIG. 2C are schematic drawings showing a structure of a surface layer of the lead-free joining material depending on various concentrations of bismuth, etc. on the surface layer, which represent concentrations at 0, 0.6, and 4.0% by weight, respectively.

FIG. 3 is another schematic drawing showing the structure of the surface layer of the lead-free joining material according to the embodiment of the present invention.

### DETAILED DESCRIPTION OF THE EMBODIMENTS

The inventors carried out analyses of substantially spherical particles of a tin-zinc alloy with either bismuth or germanium (hereinafter referred to as “bismuth, etc.”) added, which were prepared by such as centrifugal spraying. Particularly, the inventors analyzed cross-sectional structures of the particles, states of surface layers and compositions relative to the amounts of added bismuth, etc. As a result, the inventors found unprecedented knowledge described below.

To begin with, the inventors analyzed relations between amounts of the bismuth, etc. additive and concentrations of the bismuth, etc. in surface layers of the particles of the prepared tin-zinc alloys by use of an energy depressive X-ray spectrometer (EDS).

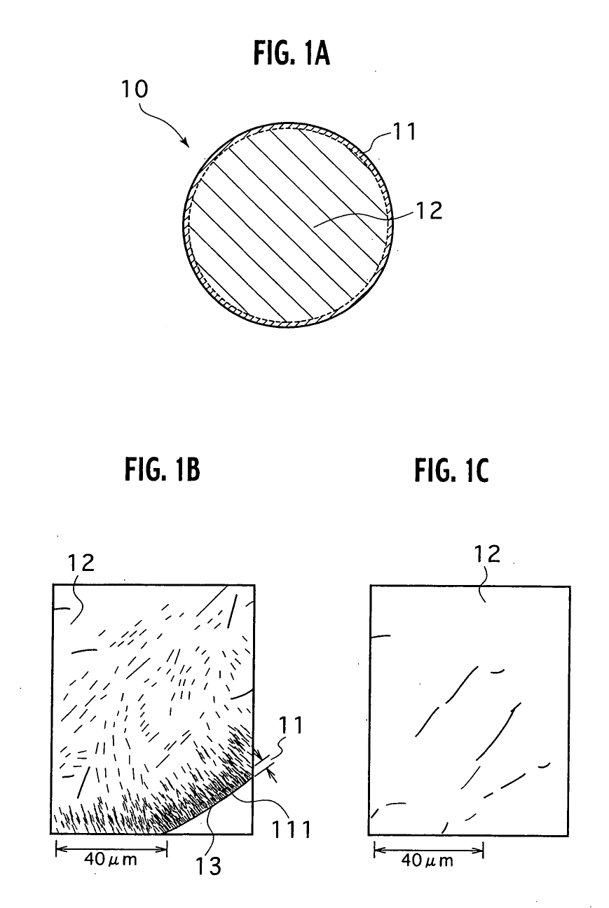

As a result, in a particle 10 of a tin-zinc alloy with addition of more than a given amount of the bismuth, etc. shown in FIG. 1A, it was found that the concentration of the bismuth, etc. in surface layer 11 was higher than a concentration of the bismuth additive, etc. in the whole particle, and that the concentration of the additive element was higher in the surface layer 11 than in a core part 12.

A cross section of the particle 10 was observed with a scanning electron microscope (SEM). FIG. 1B and FIG. 1C are views schematically showing obtained SEM images. FIG. 1B shows a cross section including an outer surface 13 and the surface layer 11 of the tin-zinc alloy particle 10. Meanwhile, FIG. 1C shows the core part 12 of the particle 10, more particularly, a cross section near the center thereof. Short black lines in FIG. 1B and FIG. 1C show the presence of needle crystals 111. As shown in FIG. 1B and FIG. 1C, in the tin-zinc alloy with of more than the given amount of bismuth added, deposition of the needle crystals 111 were observed more in the vicinity of the surface layer 11 than in the core part 12.

Moreover, the relation between the concentration of the bismuth additive, etc. in the surface layer 11 and a surface structure of the particle 10 of the tin-zinc alloy was analyzed. The concentration of the additive element was measured in an area at a depth of about 2 μm from the surface using the EDS mentioned above.

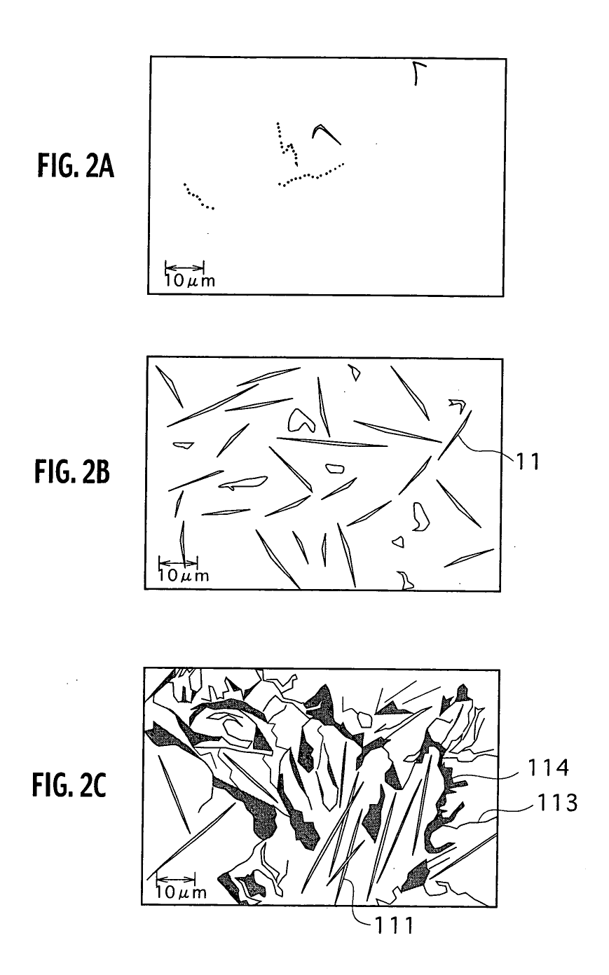

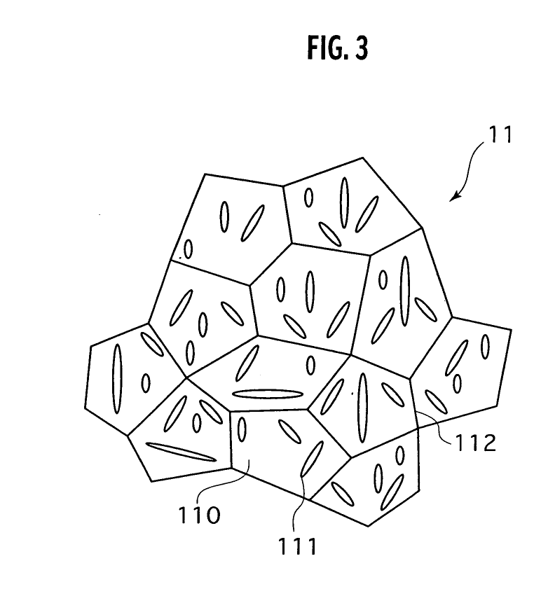

FIG. 2A to FIG. 2C are schematic drawings showing the surface structure of the particle 10, which are based on SEM photographs of the surface of the particle 10. When the bismuth, etc. additive is not added at all, the surface of the particle 10 of the tin-zinc alloy was smooth and uniform as shown in FIG. 2A. However, when the concentration of the bismuth, etc. in the surface layer 11 reached 0.6% by weight or more, the needle crystals 111 including zinc as a main component started to be deposited in the surface layer 11 as shown in FIG. 2B. FIG. 3 is a view schematically showing the structure of the surface layer 11 in this event. As shown in FIG. 3, each crystal has needle crystals 111 including zinc as the main component, and a solid-solution phase 110 including tin as a main component. Note that reference numeral 112 in FIG. 3 denotes a crystal particle boundary. The bismuth, etc. additive is mainly solid-dissolved in this tin phase of the solid-solution phase 110.

A size of the needle crystal 111 including zinc as the main component, especially a length of a crystalline axis thereof tended to increase along with an increase in the concentration of the bismuth, etc. in the surface layer. Moreover, when the crystalline length grew longer, the needle crystals tended to protrude from the surface and thereby form fractures and dents on the surface layer 11. FIG. 2C is a schematic drawing showing the state of the surface when the concentration of the bismuth, etc. additive on the surface layer 11 exceeds 4.0% by weight. Crevasse-like asperities were formed on the surface, and many fractures 113 and dents 114 were observed.

As described above, it has been made apparent from the analyses by the inventors that the concentration of the bismuth, etc. additive in the surface layer 11 has close relation with the structure of the surface layer 11.

Based on the findings, the inventors have obtained a lead-free joining material according to an embodiment to be described below, which includes a tin-zinc alloy as a main component.

Specifically, as shown in FIG. 1A and FIG. 3, a lead-free joining material according to an embodiment of the present invention includes zinc and tin as major components, and at least either bismuth or germanium as an additive element. Here, The surface layer 11 covering the core part 12 includes the needle crystals 111 including zinc as a main component, and the solid-solution phase 110 including tin as a main component for surrounding the needle crystals 111. Moreover, a concentration of the bismuth or germanium solid-dissolved in the solid-solution phase 110 of the surface layer 11 is set in a range of 0.6 to 4.0% by weight.

By adjusting the concentration of the bismuth or germanium in the surface layer 11 within the range of 0.6 to 4.0% by weight, it is possible to properly control the state of the zinc needle crystals 111 deposited in the surface layer 11. That is, when the concentration of the bismuth or germanium in the surface layer 11 exceeds 4.0% by weight, the zinc needle crystals 111 are deposited excessively in the surface layer 11 of the particle, and fractures occur in the surface layer 11 due to protrusion of the needle crystals 111 and asperities on the surface become strong. If there are asperities on the surface layer 11, adsorption of oxygen and other gases occurs easily. Accordingly, when a component is joined to a substrate by use of such a joining material having strong asperities on a surface thereof, the adsorption of gas tends to oxidize the surface of the joining material and thereby cause imperfect joining. In particular, coagulation speed is fast after reflow when a component or the like is joined to a substrate by use of a relatively small particle with a diameter of 300 μm or less as a solder ball. Accordingly, the asperities on the surface layer 11 of the solder ball or non-uniformity of the crystalline structure largely deteriorate joining reliability.

On the contrary, if the concentration of the bismuth or germanium in the surface layer 11 falls below 0.6% by weight, it is impossible to lower the melting point of the joining material by the additive element. Moreover, if the concentration of the bismuth or germanium falls to 0.3% by weight or less, it is difficult to disperse the additive uniformly.

When the concentration of the bismuth or germanium is 0.6% by weight or more, it is possible to deposit the needle crystals 111 including the zinc as the main component in the surface layer 11. The needle crystals 111 include zinc as the main component, which forms a compound easily with an electrode material such as copper, silver, or gold. Therefore, when joining a component to an electrode on a substrate by use of the above-described joining material, presence of an appropriate amount of the needle crystals 111 in the surface layer 11 can strengthen joining force between the joining material and the electrode.

Moreover, the lead-free joining material according to this embodiment has a higher concentration of the bismuth or germanium in the surface layer 11 compared to the core part 12. Accordingly, it is possible to lower the melting point and improve wettability in the surface layer 11 and to initiate joining smoothly. Meanwhile, regarding the core part 12, it is possible to set the concentration of the bismuth or germanium lower than a conventional joining material to a range of 0.3 to 1.0% by weight. Since the core part 12 accounts for a majority of the lead-free joining material, it is possible to reduce the concentration of the bismuth or germanium additive as compared to the conventional joining material. Therefore, an increase in brittleness caused by addition of the bismuth or germanium can be suppressed when joining is performed by use of this lead-free joining material, and it is thereby possible to reduce the incidence of the inferior joint.

Although description has been made in this embodiment based on the particle as an example, the condition of the surface layers is the same even if the lead-free joining material is columnar or a plate shape.

It is also to be noted that a boundary between the core part 12 and the surface layer 11 in the lead-free joining material according to this embodiment is not always strictly defined and is therefore variable depending on the size of the particle. However, the above-described concentration of the bismuth or germanium in the surface layer 11, for example, refers to a value measured with the EDS. The EDS detects the value of the additive element concentration on the surface layer at a depth of about 2 μm. Accordingly, in the embodiment, the surface layer 11 can be said to have at least a depth of 2 μm from the outermost surface.

Here, it is preferable that an average concentration of the bismuth or germanium additive in the whole joining material is set in a range of 0.6 to 1.0% by weight.

Now, a method for manufacturing a lead-free joining material according to the embodiment of the present invention will be described. For preparing the lead-free joining material, ingots of tin and zinc cut into pieces are put in a tank for melting solder as raw materials, and the ingots are heated and melted together. Moreover, an ingot of either bismuth or germanium cut into pieces is added to the solution of melted tin and zinc and the concentration of the bismuth or geranium additive in the solution is adjusted within the range of 0.6 to 1.0% by weight.

An inert gas such as nitrogen is continuously supplied to a surface of the liquid in the tank at a rate of 20 l/min. and a concentration of oxygen in the ambience of the tank is set to 100 ppm or less, or preferably to 50 ppm or less. Meanwhile, after melting, a temperature of the melted solution is set in a range of 220 to 260° C., or preferably in a range of 230 to 250° C. by feedback control.

Thereafter, part of the melted solution is formed into droplets by means of centrifugal spraying or atomization and then the droplets are discharged to a box filled with an inert gas below room temperature at a purity of 99.998% or more to cause coagulation. In this way, the droplets are solidified into substantially spherical particles. In this event, inclusion of water significantly promotes oxidation on surfaces of the particles containing zinc. Accordingly, it is preferable to set the gas temperature to 5° C. or below so as to allow water to be frozen or condensed on a surface of the box in advance. Since an oxide layer is easily formed on a surface of a joining material particle under general conditions, it is difficult to prepare a joining material having the surface layer structure of this embodiment. Therefore, in order to form the joining material of this embodiment, it is preferable to reduce the concentration of oxygen to a sufficient degree in the ambience at the time of condensation and to increase condensation speed of the droplets as much as possible so that the droplets are preferably condensed in an instant. In this way, it is possible to avoid oxidation on the surface of the particle and thereby to form the surface layer according to this embodiment.

Next, a joining method using the lead-free joining material according to the embodiment of the present of invention will be described while taking a case of mounting a quad flat package (QFP) on a glass-epoxy substrate as an example. First, the particles of the lead-free joining material according to the embodiment of the present invention are mixed with a flux to prepare a solder paste. As the flux, it is possible to use a mixture prepared by blending and heating about 46 parts by weight of polymerized rosin (turpentine), about 44.5 parts by weight of a solvent such as terpineol, about 8 parts by weight of hydrogenated castor oil, about 0.9 part by weight of an activator including diphyenilguanidine hydrobromide as a main component, about 0.3 part by weight of palmitic acid, and about 0.3 part by weight of ethylamine hydrochloride, for example.

This solder paste is printed on a glass-epoxy substrate provided with copper pad patterns corresponding to QFP pins in a thickness of about 150 μm by use of a stainless steel screen. Thereafter, the QFP is mounted on the glass-epoxy substrate. Then the substrate with the QFP mounted is put into a furnace to reflow the solder paste. Reflow conditions are set at for example, to a time period of 6 minutes, a preliminary heating temperature at 150° C., a peak heating temperature at 220° C., and to an atmospheric ambience inside the furnace.

Here, it is also possible to apply a joining method which adopts a heating method called “Vapor Phase Solderring (VPS)” using paraffin as a heat transfer medium.

In comparison with joining by use of a conventional lead-free joining material including a tin-zinc alloy, the lead-free joining material of the present invention has fine wettability and does not occur imperfect joining due to asperities on the surface layer. Moreover, since a compound is formed by the zinc in the needle crystals on the surface layer and a copper pad, it is possible to obtain high joining strength. Moreover, since the concentration of the bismuth additive in the whole joining material is adjusted lower than the conventional joining material, it is possible to improve the brittleness of a connection. In other words, the surface layer is easily melted because the concentration of the bismuth additive is high, and it is thereby possible to obtain secure joining even if the temperature varies during a joining operation. Moreover, since the concentration of the bismuth additive is low in the core part of the joining material, the joining material can exert tensile force which is characteristic in tin-zinc alloys. Therefore, when electronic components are joined onto a substrate, it is possible to prevent occurrence of a fracture even if tensile force is applied to the connection due to a camber of the substrate, the tensile force caused by deformation of the joining material.

Here, as another joining method using the lead-free joining material according to the embodiment of the present invention, it is also possible to apply a method including pre-coating a flux on an electrode of a package for chip size package (CSP), mounting the lead-free joining material according to this embodiment on the flux, and reflowing under the similar conditions described above.

Application of the lead-free joining material according to the embodiment of the present invention includes fields such as, joining of conductive portions of an integrated circuit (IC) package or a central processing unit (CPU) used in semiconductor fields, joining electric circuits in a hard disk or a liquid crystal display panel, and connections of high-density components such as cable connectors which are widely used for connection of IC cards, personal computers and printers, or optical connectors with increasing density, used in communication cables.

Meanwhile, aspects of mounting on substrates include single-sided surface mounting, double-sided surface mounting, double-sided surface mounting of components with leads, single-sided surface mounting components with leads, and the like. Moreover, mounted components typically includes ICs as active components, and package configurations thereof includes a ball grid array (BGA), a flip chip-ball grid array (FC-BGA), a chip size package (CSP), a planar light-wave circuit (PLC), a multi-chip module (MCM), an output enable-MCM (OE-MCM), high-density mounting achieved by overlapping chips, and the like.

### EXAMPLES

Now, examples of the present invention will be described. It is to be noted that conditions and characteristics of respective examples and comparative examples are shown in Table 1 and Table 2 to be described later.

### Example 1

182.8 kg of tin ingot cut into pieces (size: 100 mm×50 mm×10 mm or less) at a purity of 99.99% or more was put in a box-shaped tank for melting solder (inside dimensions: 700 mm×700 mm×800 mm) and was heated and completely melted with a heater surrounding the exterior of the tank. During melting, nitrogen was supplied to the surface of the liquid so that the concentration of oxygen in the ambience was set to 50 ppm or less. The temperature of the melted solution after melting was maintained at 250° C. by feedback control.

Next, 16 kg of zinc ingot cut into pieces (size: 100 mm×50 mm×10 mm or less) at a purity of 99.99% or more was added to the melted solution and dissolved. Moreover, while maintaining the concentration of oxygen in an ambience of 40 ppm, 1.2 kg of bismuth ingot cut into pieces (size: 20 mm×20 mm×10 mm or less) at a purity of 99.99% or more was added to the above described melted solution and stirred with a ceramic stick and dissolved. Then the temperature of the melted solution was once again maintained at 250° C. by feedback control. In this way, the concentration of the bismuth additive in the melted solution was adjusted to 0.6% by weight.

Part of the melted solution was introduced out of the tank through a valve fitted to a side face at a height of 100 mm from the bottom the tank, and droplets were dropped from a nozzle having a diameter of 360 μm onto a rapidly spinning disk. The droplets dropped on the disk were scattered in radial directions by centrifugal force. The droplets were rapidly cooled down and formed into a lead-free joining material having the shape of substantially spherical particles in the course of condensation and solidification. Here, condensation and solidification took place in a box filled with nitrogen gas at a purity of 99.998% or more and at a temperature of 5° C. or below. Numerous particles of the solidified joining material were put into a rotary classifier and 5 kg of the joining material with particle size of 760±20 μm were collected. In this way, the substantially spherical lead-free joining material was obtained.

Part of the collected lead-free joining material particle was picked out and an incidence rate of fractures and dents on the surface in an area of 200 μm×200 μm was examined with an optical microscope. The incidence rate of fractures and dents remained at around 5% of the observed surface. The incidence rate of fractures was 2%. Meanwhile, the state from the outermost surface to a depth of 2 μm was examined with the EDS under a condition of an acceleration voltage of 50 keV. As a result, numerous needle crystals containing 50 to 98% of zinc with lengths of 10 to 30 μm and widths of 0.1 to 2 μm were found. Moreover, the needle crystals were surrounded by a solid-solution phase which included tin as a main component with solid-dissolved bismuth additives of 0.6 to 1.2% by weight. Note that the concentration of the solid-dissolved bismuth was measured in plural positions on the surface layer.

Furthermore, the observed particulate lead-free joining material was sectioned along a plane including a central axis thereof, and the content of the bismuth at the center of the plane was examined. The content was 0.5 to 0.6% by weight.

Next, 10 particles were taken out of the collected particulate lead-free joining material, and were placed one-by-one on phosphorous-deoxidized copper plates (size: 35 mm×35 mm×0.3 mm thick). Then 25% by weight of turpentine dissolved in isopropyl alcohol (IPA) was dropped in an amount of 0.05 ml from above onto the respective particles with a dropper. One minute later, these phosphorous-deoxidized copper plates were subjected to reflow-heating in the atmospheric ambience at a conveyor speed of 0.8 m/min. and at a peak temperature of 220° C. and then to natural cooling. After cooling, the shear strengths of the particles joined to the copper plates were measured. The average shear strength of connections in a similar evaluation test using the conventional eutectic tin-lead solder was about 4N. Meanwhile, the shear strength of joining by use of the lead-free joining material of Example 1 was almost equivalent to or stronger than the conventional eutectic tin-lead solder. Hence, the lead-free joining material of Example 1 was proved to possess fine joining strength.

### Example 2 and Example 3

The lead-free joining material was prepared under the similar conditions to Example 1. However, the concentration of the bismuth additive in the melted solution was adjusted to 0.8% by weight in Example 2 and 1.0% by weight in Example 3, respectively.

In the lead-free joining material of Example 2, the incidence rate of fractures on the surface was 4%, the concentration of the bismuth of the solid-solution phase in the surface layer was 0.8 to 1.6% by weight, and the maximum length of the needle crystal was about 50 μm. On the other hand, in the lead-free joining material of Example 3, the incidence rate of fractures on the surface was 5%, the concentration of the bismuth in the solid-solution phase in the surface layer was 0.9 to 1.9% by weight, and the maximum length of the needle crystal was about 70 μm. Excellent joining characteristics almost equivalent to or better than the conventional eutectic tin-lead solder were obtained in both Examples 2 and 3.

### Examples 4 to 6

The lead-free joining material was prepared under the similar conditions to Example 1. However, in Examples 4 to 6, germanium was added to the melted solution instead of the bismuth. The concentration of the germanium additive in the melted solution was adjusted to 0.6% by weight in Example 4, 0.8% by weight in Example 5, and 1.0% by weight in Example 6.

Similar results were also obtained when the germanium was added instead of the bismuth. To be more precise, in the lead-free joining material of Example 4, the incidence rate of fractures on the surface was 3%, the concentration of the germanium of the solid-solution phase in the surface layer was 0.6 to 1.2% by weight, and the maximum length of the needle crystal was about 30 μm. In the lead-free joining material of Example 5, the incidence rate of fractures on the surface was 4%, the concentration of the germanium of the solid-solution phase in the surface layer was 0.8 to 1.6% by weight, and the maximum length of the needle crystal was about 50 μm. In the lead-free joining material of Example 6, the incidence rate of fractures on the surface was 6%, the concentration of the germanium of the solid-solution phase in the surface layer was 0.9 to 1.9% by weight, and the maximum length of the needle crystal was about 50 μm. Excellent joining characteristics almost equivalent to or better than the conventional eutectic tin-lead solder were obtained in all of Examples 4 to 6.

### Examples 7 to 9

The lead-free joining material was prepared under the similar conditions to Example 1. However, a nozzle having a diameter of 250 μm was used in Examples 7 to 9. In this case, the lead-free joining material having a diameter of about 500 μm was collected in the course of classification. Moreover, the concentration of the bismuth additive in the melted solution was adjusted to 0.6% by weight in Example 7, 0.8% by weight in Example 8, and 1.0% by weight in Example 9.

In the lead-free joining material of Example 7, the incidence rate of fractures on the surface was 2%, the concentration of the bismuth of the solid-solution phase in the surface layer was 0.6 to 1.2% by weight, and the maximum length of the needle crystal was about 30 μm. In the lead-free joining material of Example 8, the incidence rate of fractures on the surface was 4%, the concentration of the bismuth of the solid-solution phase in the surface layer was 0.8 to 1.8% by weight, and the maximum length of the needle crystal was about 40 μm. Moreover, in the lead-free joining material of Example 9, the incidence rate of fractures on the surface was 6%, the concentration of the bismuth of the solid-solution phase in the surface layer was 0.9 to 2.6% by weight, and the maximum length of the needle crystal was about 60 μm. Excellent joining characteristics almost equivalent to or better than the conventional eutectic tin-lead solder were obtained in all of Examples 7 to 9.

No significant change was observed in terms of the relation between the concentration of the bismuth in the surface layer and the structure of the surface layer when the particle size of the lead-free joining material was changed.

### Examples 10 to 12

The lead-free joining material was prepared under the similar conditions to Example 1. However, a nozzle having a diameter of 70 μm was used in Examples 10 to 12. Moreover, the lead-free joining material having a diameter of about 100 μm was collected in the course of classification. Here, the concentration of the bismuth additive in the melted solution was adjusted to 0.6% by weight in Example 10, 0.8% by weight in Example 11, and 1.0% by weight in Example 12.

In the lead-free joining material of Example 10, the incidence rate of fractures on the surface was 3%, the concentration of the bismuth of the solid-solution phase in the surface layer was 0.6 to 1.4% by weight, and the maximum length of the needle crystal was about 20 μm. In the lead-free joining material of Example 11, the incidence rate of fractures on the surface was 7%, the concentration of the bismuth of the solid-solution phase in the surface layer was 0.8 to 2.8% by weight, and the maximum length of the needle crystal was about 40 μm. Moreover, in the lead-free joining material of Example 12, the incidence rate of fractures on the surface was 7%, the concentration of the bismuth of the solid-solution phase in the surface layer was 0.9 to 3.6% by weight, and the maximum length of the needle crystal was about 60 μm. Excellent joining characteristics almost equivalent to or better than the conventional eutectic tin-lead solder were obtained in all of Examples 10 to 12.

No significant change was observed in terms of the relation between the concentration of the bismuth in the surface layer and the structure of the surface layer when the particle size of the lead-free joining material was changed.

### Examples 13 to 15

The lead-free joining material was prepared under the similar conditions to Example 1. However, a nozzle having a diameter of 70 μm was used in Examples 13 to 15. Moreover, the lead-free joining material having a diameter of about 100 μm was collected in the course of classification. In addition, germanium was added to the melted solution instead of the bismuth. The concentration of the germanium additive in the melted solution was adjusted to 0.6% by weight in Example 13, 0.8% by weight in Example 14, and 1.0% by weight in Example 15.

Approximately the same results were also obtained when the germanium was added instead of the bismuth. To be more precise, in the lead-free joining material of Example 13, the incidence rate of fractures on the surface was 3%, the concentration of the germanium of the solid-solution phase in the surface layer was 0.6 to 1.4% by weight, and the maximum length of the needle crystal was about 20 μm. In the lead-free joining material of Example 14, the incidence rate of fractures on the surface was 5%, the concentration of the germanium of the solid-solution phase in the surface layer was 0.8 to 2.9% by weight, and the maximum length of the needle crystal was about 40 μm. In the lead-free joining material of Example 15, the incidence rate of fractures on the surface was 8%, the concentration of the germanium of the solid-solution phase in the surface layer was 0.9 to 4.0% by weight, and the maximum length of the needle crystal was about 70 μm. Excellent joining characteristics almost equivalent to or better than the conventional eutectic tin-lead solder were obtained in all of Examples 13 to 15.

### Comparative Examples 1 and 2

Lead-free joining material was prepared under the similar conditions to Example 1. However, the concentration of the bismuth additive in the melted solution was adjusted to 0.3% by weight in Comparative Example 1 and 1.2% by weight in Comparative Example 2.

In the lead-free joining material of Comparative Example 1, the concentration of the bismuth of the solid-solution phase in the surface layer was 0.3 to 1.0% by weight, and the maximum length of the needle crystal was about 30 μm. The surface of the particle was substantially uniform and smooth, and the incidence rate of fractures on the surface was only 1%. However, concerning the joining characteristic thereof, 20% of the lead-free joining material had shear strength of 3.2 N or less, which is inferior to the shear strength of 4 N observed in the connections of the conventional tin-lead solder.

Further, in the joining material of Comparative Example 2, the concentration of the bismuth of the solid-solution phase in the surface layer was 2.8 to 4.6% by weight, and the maximum length of the needle crystal reached 100 μm. The surface of the particle included severe asperities, and the incidence rate of fractures on the surface reached 8%. Concerning the joining characteristic thereof, 40% of the lead-free joining material had shear strength of 3.2 N or less, which is inferior to the shear strength of 4 N observed in the connections of the conventional tin-lead solder.

### Comparative Examples 3 and 4

The lead-free joining material was prepared under the similar conditions to Example 4. However, the concentration of the germanium additive in the melted solution was adjusted to 0.3% by weight in Comparative Example 3 and 1.2% by weight in Comparative Example 4.

In the lead-free joining material of Comparative Example 3, the concentration of the germanium of the solid-solution phase in the surface layer was 0.3 to 1.0% by weight, and the maximum length of the needle crystal was about 30 μm. The surface of the particle was substantially uniform and smooth, and the incidence rate of fractures on the surface was only 1%. However, concerning the joining characteristic thereof, 20% of the lead-free joining material had shear strength of 3.2 N, which is to the shear strength of 4 N observed in the connections of the conventional tin-lead solder.

Further, in the joining material of Comparative Example 4, the concentration of the germanium of the solid-solution phase in the surface layer was 2.6 to 4.8% by weight, and the maximum length of the needle crystal reached 100 μm. The surface of the particle included severe asperities, and the incidence rate of fractures on the surface reached 8%. Concerning the joining characteristic thereof, 40% of the lead-free joining material had shear strength inferior to the shear strength of 4 N observed in the connections of the conventional tin-lead solder.

Although the lead-free joining material and the joining method using the lead-free joining material of the present invention have been described with reference to certain embodiments and examples, it is to be understood that the present invention shall not be limited to the embodiments and the examples described herein.

As described above, compared to a conventional joining material using a tin-zinc binary alloy, the lead-free joining material and the joining method using the lead-free joining material of the present invention enables to provide highly reliable joining with excellent workability, high yields, and resistance to cracks after joining.

TABLE 1

| | | | | | Bi/Ge | | |
|---|---|---|---|---|---|---|---|
| | | | | | concentration | | |
| | | | | | of solid-solution | Maximum | |
| | | Average | Average | Incidence | phase in | length of | |
| | Diameter | concentration | concentration | rate of | surface layer | needle | |
| Example | of nozzle | of added Bi | of added Ge | fractures | (wt %) | crystal | Joining |
| No. | (μm) | (wt %) | (wt %) | (%) | (average) | (μm) | characteristics |
| 1 | 380 | 0.6 | 0 | 2 | 0.6˜1.2 | 30 | Good |
| | | | | | (0.9) | | |
| 2 | 380 | 0.8 | 0 | 4 | 0.8˜1.6 | 50 | Good |
| | | | | | (1.2) | | |
| 3 | 380 | 1.0 | 0 | 5 | 0.9˜1.9 | 70 | Good |
| | | | | | (1.4) | | |
| 4 | 380 | 0 | 0.6 | 3 | 0.6˜1.2 | 30 | Good |
| | | | | | (0.9) | | |
| 5 | 380 | 0 | 0.8 | 4 | 0.8˜1.6 | 50 | Good |
| | | | | | (1.2) | | |
| 6 | 380 | 0 | 1.0 | 6 | 0.9˜1.9 | 80 | Good |
| | | | | | (1.4) | | |
| 7 | 250 | 0.6 | 0 | 2 | 0.6˜1.2 | 30 | Good |
| | | | | | (0.9) | | |
| 8 | 250 | 0.8 | 0 | 4 | 0.8˜1.8 | 40 | Good |
| | | | | | (1.3) | | |
| 9 | 250 | 1.0 | 0 | 6 | 0.9˜2.6 | 60 | Good |
| | | | | | (1.8) | | |
| 10 | 70 | 0.6 | 0 | 3 | 0.6˜1.4 | 20 | Good |
| | | | | | (1.0) | | |
| 11 | 70 | 0.8 | 0 | 4 | 0.8˜2.8 | 40 | Good |
| | | | | | (1.8) | | |
| 12 | 70 | 1.0 | 0 | 7 | 0.9˜3.6 | 60 | Good |
| | | | | | (2.3) | | |
| 13 | 70 | 0 | 0.6 | 3 | 0.6˜1.4 | 20 | Good |
| | | | | | (1.0) | | |
| 14 | 70 | 0 | 0.8 | 5 | 0.8˜2.9 | 40 | Good |
| | | | | | (1.9) | | |
| 15 | 70 | 0 | 1.0 | 8 | 0.9˜4.0 | 70 | Good |
| | | | | | (2.5) | | |

TABLE 2

| | | | | | Bi/Ge | | |
|---|---|---|---|---|---|---|---|
| | | | | | concentration | | |
| | | | | | of | | |
| | | | Average | | solid-solution | Maximum | Incidence |
| | | Average | concentration | Incidence | phase in | length | rate of |
| Comparative | Diameter | concentration | of added | rate of | surface layer | of needle | inferior |
| Example | of nozzle | of added Bi | Ge | fractures | (wt %) | crystal | joint |
| No. | (μm) | (wt %) | (wt %) | (%) | (average) | (μm) | (%) |
| 1 | 380 | 0.3 | 0 | 1 | 0.3˜1.0 | 30 | 20 |
| | | | | | (0.7) | | |
| 2 | 380 | 1.2 | 0 | 8 | 2.8˜4.6 | 100 | 40 |
| | | | | | (3.7) | | |
| 3 | 380 | 0 | 0.3 | 1 | 0.3˜1.0 | 30 | 20 |
| | | | | | (0.7) | | |
| 4 | 380 | 0 | 1.2 | 8 | 2.6˜4.8 | 100 | 40 |
| | | | | | (3.7) | | |

What is claimed is:

1. A lead-free joining material, comprising:
(a) a core part including zinc and tin as major components and at least any one of bismuth and germanium as an additive element; and
(b) a surface layer covering the core part and including the major components and the additive element, the surface layer including;
(i) a solid-solution phase in which a concentration of the additive element is higher than a concentration of the additive element in the core part, and the concentration of the additive element in the solid-solution phase is in a range of 0.6 to 4.0% by weight; and
(ii) a needle crystal which is dispersed in the solid-solution phase and includes the zinc as a main component.

2. The lead-free joining material according to claim 1,
wherein the concentration of the additive element in the core part is in a range of 0.3 to 1.0% by weight.

3. The lead-free joining material according to claim 1,
wherein the surface layer has a depth of at least 2,,m from an outermost surface.

4. The lead-free joining material according to claim 1,
wherein the lead-free joining material is a particle which is substantially spherical.

5. The lead-free joining material according to claim 1,
wherein an average concentration of the additive element in the whole lead-free joining material is in a range of 0.6 to 1.0% by weight.

6. A lead-free solder paste, comprising:
(A) a lead-free joining material, including:
(a) a core part including zinc and tin as major components and at least any one of bismuth and germanium as an additive element; and
(b) a surface layer covering the core part and including the major components and the additive element, the surface layer including;
(i) a solid-solution phase in which a concentration of the additive element is higher than a concentration of the additive element in the core part, and the concentration of the additive element in the solid-solution phase is in a range of 0.6 to 4.0% by weight; and
(ii) a needle crystal which is dispersed in the solid-solution phase and includes the zinc as a main component; and
(B) a flux.

7. The lead-free solder paste according to claim 6,
wherein the concentration of the additive element in the core part is in a range of 0.3 to 1.0% by weight.

8. The lead-free solder paste according to claim 6,
wherein the surface layer has a depth of at least 2,,m from an outermost surface.

9. The lead-free solder paste according to claim 6,
wherein the lead-free joining material is a particle which is substantially spherical.

10. The lead-free solder paste according to claim 6,
wherein an average concentration of the additive element in the whole lead-free joining material is in a range of 0.6 to 1.0% by weight.

11. A joining method using a lead-free joining material, comprising:
coating a solder paste to a connection, the solder paste being formed by blending the lead-free joining material and a flux, and
reflowing the solder paste,
wherein the lead-free joining material includes:
(a) a core part including zinc and tin as major components and at least any one of bismuth and germanium as an additive element; and
(b) a surface layer covering the core part and including the major components and the additive element, the surface layer including;
(i) a solid-solution phase in which a concentration of the additive element is higher than a concentration of the additive element in the core part, and the concentration of the additive element in the solid-solution phase is in a range of 0.6 to 4.0% by weight; and
(ii) a needle crystal which is dispersed in the solid-solution phase and includes the zinc as a main component.

12. The joining method according to claim 11,
wherein the concentration of the additive element in the core part is in a range of 0.3 to 1.0% by weight.

13. The joining method according to claim 11,
wherein the surface layer has a depth of at least 2,,m from an outermost surface.

14. The joining method according to claim 11,
wherein the lead-free joining material is a particle which is substantially spherical.

15. The joining method according to claim 11,
wherein an average concentration of the additive element in the whole lead-free joining material is in a range of 0.6 to 1.0% by weight.

16. A joining method using a lead-free joining material, comprising:
placing the lead-free joining material on a connection pre-coated with a flux; and
reflowing the flux and the lead-free joining material,
wherein the lead-free joining material includes:
(a) a core part including zinc and tin as major components and at least any one of bismuth and germanium as an additive element; and
(b) a surface layer covering the core part and including the major components and the additive element, the surface layer including;
(i) a solid-solution phase in which a concentration of the additive element is higher than a concentration of the additive element in the core part, and the concentration of the additive element in the solid-solution phase is in a range of 0.6 to 4.0% by weight; and
(ii) a needle crystal which is dispersed in the solid-solution phase and includes the zinc as a main component.

17. The joining method according to claim 16,
wherein the concentration of the additive element in the core part is in a range of 0.3 to 1.0% by weight.

18. The joining method according to claim 16,
wherein the surface layer has a depth of at least 2,,m from an outermost surface.

19. The joining method according to claim 16,
wherein the lead-free joining material is a particle which is substantially spherical.

20. The joining method according to claim 16,
wherein an average concentration of the additive element in the whole lead-free joining material is in a range of 0.6 to 1.0% by weight.
